(19) United States
(12) Patent Application Publication
(10) Pub. No.: US 2023/0360160 A1
(43) Pub. Date: Nov. 9, 2023

(54) MACHINE LEARNING BASED FOREST MANAGEMENT

(71) Applicants: AALTO UNIVERSITY FOUNDATION SR, Aalto (FI); HELSINGIN YLIOPISTO, Aalto (FI)

(72) Inventors: Philipp BACK, Aalto (FI); Antti SUOMINEN, Aalto (FI); Pekka MALO, Aalto (FI); Olli TAHVONEN, Helsingin yliopisto (FI)

(73) Assignees: AALTO UNIVERSITY FOUNDATION SR, Aalto (FI); HELSINGIN YLIOPISTO, Helsingin yliopisto (FI)

(21) Appl. No.: 18/029,091

(22) PCT Filed: Sep. 29, 2021
(86) PCT No.: PCT/FI2021/050645

§ 371 Date: Mar. 28, 2023

(30) Foreign Application Priority Data
Sep. 30, 2020 (FI) 20207158

(51) Int. Cl. G06Q 50/26; G06Q 10/0631

(52) U.S. Cl. CPC G06Q 50/26; G06Q 10/0631

(57) ABSTRACT

Machine learning based forest management is disclosed. A set of input data related to a forest stand is accessed. A forest management plan defining at least one forest management activity for the forest stand is determined based on the accessed set of input data and at least one forest management preference. The determining of the forest management plan for the forest stand is performed by applying a parameterized policy to the accessed set of input data. The parameterized policy has been trained via a machine learning process using a forest development related simulation model.

### TECHNICAL FIELD

The present disclosure relates to the field of machine learning, and, more particularly, to machine learning based forest management.

### BACKGROUND

Forest management is a branch of forestry. The basic unit in forest management is a forest stand, a uniform forest compartment that is usually around one hectare in size. A forest plan may define future forest management activities for individual forest stands.

Forest management operations directly and significantly affect, e.g., the profitability of forest assets. Boreal and temperate forests of Europe and North America grow slowly—it can take seedlings up to a century to grow to a commercially viable size. Choosing the correct forest management operations and timing them optimally over a long horizon thus becomes a key challenge for forest stakeholders, especially on supply side of the forestry value chain.

Forestry stakeholders are persons or legal entities who operate within the forest industry ecosystem. The supply side of the forest value chain contains those stakeholders who are directly or indirectly involved in the production and sale of timber for further processing (e.g., into pulp and paper, wood products, etc.). This includes—but is not limited to—institutional and private forest owners, forestry consultants, insurance companies, banks, financial advisers, ESG (Environmental, Social, and Corporate Governance) and impact investors, and state authorities.

Forests represent complex dynamic systems whose development and corresponding worth are affected by numerous sources of uncertainty. Yet, current approaches in forest management (such as Silvicultural guidelines) are deterministic, i.e., they ignore any form of uncertainty or randomness in forest development. Instead, Silvicultural guidelines offer forestry stakeholders rules-of-thumb and example cases to estimate asset valuations or optimal management strategies.

Silviculture best-practice guidelines represent oversimplifications without theoretical backing and ignore the dynamic, uncertain nature of forestry. This shortcoming may become especially pronounced when considering non-traditional forestry strategies. Research has shown that multiple-tree-species Continuous Cover Forestry (CCF) does not only support biodiversity and carbon storage, but also counters various threats of climate change and thus is at least in some cases more advantageous than traditional clear-cutting under single-species Rotation Forestry (RF). However, while RF strategies are grounded in a well-known (albeit somewhat restrictive) scientific basis and have long been applied in practice, CCF is more complex and leads to challenging optimization problems that are normally computed only under strong simplifications.

Existing computation without oversimplifications may require days or even weeks to find a single optimal CCF strategy. Institutional forest owners would need to repeat this process every five to ten years for each of their tens of thousands of forest stands; an unreasonable burden. Additionally, forest owners are unable to compare the economic consequences of CCF and RF in order to make a rational choice between these alternatives. Consequently, forestry stakeholders are often making decisions based on inaccurate valuations or on an imperfect understanding of what management strategy is best for a particular objective. The existing methods based on Silviculture guidelines may lead to economically sub-optimal forest management decisions and to inaccurate forest asset valuations, which in turn may lead to economic losses and unnecessary environmental destruction.

### SUMMARY

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

An example embodiment of an apparatus is configured to access a set of input data related to a forest stand. The apparatus is further configured to determine a forest management plan defining at least one forest management activity for the forest stand based on the accessed set of input data and at least one forest management preference. The determining of the forest management plan for the forest stand is performed by applying a parameterized policy to the accessed set of input data, the parameterized policy having been trained via a machine learning process using a forest development related simulation model.

An example embodiment of an apparatus comprises at least one processor, and at least one memory including computer program code. The at least one memory and the computer program code are configured to, with the at least one processor, cause the apparatus to at least perform: accessing a set of input data related to a forest stand, and determining a forest management plan defining at least one forest management activity for the forest stand based on the accessed set of input data and at least one forest management preference. The determining of the forest management plan for the forest stand is performed by applying a parameterized policy to the accessed set of input data, the parameterized policy having been trained via a machine learning process using a forest development related simulation model.

An example embodiment of a client device comprises means for performing: accessing a set of input data related to a forest stand, and determining a forest management plan defining at least one forest management activity for the forest stand based on the accessed set of input data and at least one forest management preference. The determining of the forest management plan for the forest stand is performed by applying a parameterized policy to the accessed set of input data, the parameterized policy having been trained via a machine learning process using a forest development related simulation model.

An example embodiment of a method comprises: accessing, by an apparatus, a set of input data related to a forest stand, and determining, by the apparatus, a forest management plan defining at least one forest management activity for the forest stand based on the accessed set of input data and at least one forest management preference. The determining of the forest management plan for the forest stand is performed by applying a parameterized policy to the accessed set of input data, the parameterized policy having been trained via a machine learning process using a forest development related simulation model.

An example embodiment of a computer program comprises instructions for causing an apparatus to perform at least the following: accessing a set of input data related to a forest stand, and determining a forest management plan defining at least one forest management activity for the forest stand based on the accessed set of input data and at least one forest management preference. The determining of the forest management plan for the forest stand is performed by applying a parameterized policy to the accessed set of input data, the parameterized policy having been trained via a machine learning process using a forest development related simulation model.

In an example embodiment, alternatively or in addition to the above-described example embodiments, the set of input data comprises at least one of size data, species data, quantity data, or age data of trees in the forest stand.

In an example embodiment, alternatively or in addition to the above-described example embodiments, the set of input data further comprises image data related to the trees in the forest stand.

In an example embodiment, alternatively or in addition to the above-described example embodiments, the at least one forest management preference comprises at least one of maintaining biodiversity of the forest stand, improving carbon storage of the forest stand, maximizing timber revenue of the forest stand, or maximizing harvesting profit of the forest stand.

In an example embodiment, alternatively or in addition to the above-described example embodiments, the at least one forest management activity comprises an instruction to apply at least a thinning or a clearcut to the forest stand, or an instruction to wait.

In an example embodiment, alternatively or in addition to the above-described example embodiments, the at least one forest management activity further comprises a harvesting schedule for the forest stand.

In an example embodiment, alternatively or in addition to the above-described example embodiments, the harvesting schedule comprises at least one of a harvest target, a harvest timing, or a harvest intensity.

In an example embodiment, alternatively or in addition to the above-described example embodiments, the at least one forest management activity further comprises at least one of a scenario-based carbon analysis for the forest stand or a scenario-based sustainability analysis for the forest stand.

In an example embodiment, alternatively or in addition to the above-described example embodiments, the forest development related simulation model comprises at least one of:

a deterministic forest development related simulation model comprising a forestry growth model with no uncertainty factor model; or a stochastic forest development related simulation model comprising a forestry growth model and an uncertainty factor model.

In an example embodiment, alternatively or in addition to the above-described example embodiments, the uncertainty factor model is based on at least one of a random tree factor, a weather factor, a natural disaster factor, or an economic risk factor.

In an example embodiment, alternatively or in addition to the above-described example embodiments, the forest development related simulation model further comprises an empirically estimated model for forest dynamics.

In an example embodiment, alternatively or in addition to the above-described example embodiments, the forest dynamics comprise at least one of diameter increment, mortality or natural regeneration of trees.

In an example embodiment, alternatively or in addition to the above-described example embodiments, the forest stand comprises a single-species forest stand or a multiple-species forest stand.

In an example embodiment, alternatively or in addition to the above-described example embodiments, the forest stand comprises an even-aged forest stand or an uneven-aged forest stand.

In an example embodiment, alternatively or in addition to the above-described example embodiments, the machine learning process comprises a reinforcement learning, RL, process, an approximate dynamic programming process, or an evolutionary computation process.

### DESCRIPTION OF THE DRAWINGS

The accompanying drawings, which are included to provide a further understanding of the embodiments and constitute a part of this specification, illustrate embodiments and together with the description help to explain the principles of the embodiments. In the drawings:

FIG. 1 illustrates forest development under rotation forestry and continuous cover forestry;

FIG. 2A shows an example embodiment of the subject matter described herein illustrating an example apparatus and its various input data sets, where various embodiments of the present disclosure may be implemented;

FIG. 2B shows an example embodiment of the subject matter described herein illustrating the example apparatus in more detail;

FIG. 3 shows an example embodiment of the subject matter described herein illustrating a method

FIG. 4 illustrates agent-environment interaction in a size-structured optimization problem;

FIG. 5 illustrates a parameterized action space; and

FIG. 6 illustrates an example neural network structure.

Like reference numerals are used to designate like parts in the accompanying drawings.

### DETAILED DESCRIPTION

Reference will now be made in detail to embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

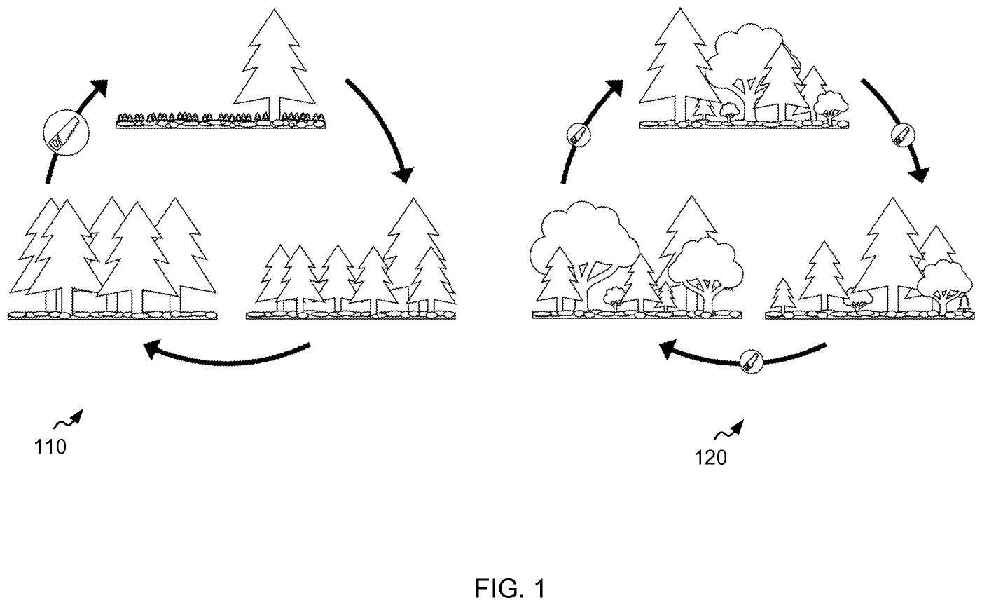

An element of forest management is harvesting, i.e., the felling of trees. E.g., in boreal and temperate forests of Europe and North America, forest management regimes may be divided into rotation forestry (RF) with clearcuts and continuous cover forestry (CCF). FIG. 1 illustrates forest development under rotation forestry 110 and continuous cover forestry 120. In rotation forestry 110, a forest stand may be thinned (only a part of the trees is harvested) but is eventually clearcut (all trees are harvested) at the end of a rotation (the time between two clearcuts) which is followed by artificial regeneration of the stand. In contrast, in continuous cover forestry 120, a stand is never clearcut and forestry relies on natural regeneration of trees and revenues from thinnings.

In the following, various example embodiments will be discussed. At least some of these example embodiments may allow machine learning based forest management. At least some of these example embodiments may allow a stochastic solution that can incorporate various sources of uncertainty to model various forestry styles, compare strategies, provide accurate valuations, and/or offer flexible and customizable forest planning.

At least some of these example embodiments may allow combining forest information from disparate sources with machine learning to prescribe optimal forest management policies for single- and multiple-species forest stands with or without uncertainty. At least in some embodiments, the learning mechanism may utilize deep reinforcement learning and/or approximate dynamic programming and/or an evolutionary computation process. At least in some embodiments, the learning mechanism may correspond naturally to problems where the goal is to prescribe an optimal strategy in the form of sequential decision making, thereby providing an ideal approach for the forest management where harvesting decisions (actions) are made year after year based on the current forest state with the goal of, e.g., maintaining biodiversity of the forest stand, improving carbon storage of the forest stand, maximizing timber revenue of the forest stand, and/or maximizing harvesting profit of the forest stand.

While traditional forest management methods may take days or even weeks to find a single optimal CCF strategy, at least some of the embodiments described herein may allow converging within minutes. This drastic improvement in computational efficiency allows the apparatus 200 to be trained on multiple initial forest states to learn a global policy, i.e., a mapping from various forest states to optimal actions. When a requesting entity (e.g., a forestry stakeholder) inputs a previously unseen forest state, the apparatus 200 may prescribe, e.g., an optimal management regime (RF or CCF), a corresponding harvesting schedule (harvest target, timing, intensity), and the forest's net present value (NPV) instantaneously, without need for re-training.

Furthermore, at least some of the embodiments described herein may allow incorporating uncertainty in physical (e.g., weather, natural disasters) and/or economical (e.g., timber prices, exchange rates) factors which may lead to more robust strategies. Furthermore, at least some of the embodiments described herein may allow incorporating non-monetary goals, such as carbon storage or biodiversity, to provide users with a detailed scenario-based carbon or sustainability analysis. In other words, at least some of the embodiments described herein may allow combining forest data from disparate sources with advanced machine learning to deliver accurate valuations and optimal management strategies for forests under uncertainty.

In yet other words, at least some of the embodiments described herein may allow combining forest information from disparate sources with machine learning to prescribe optimal forest management policies and resulting forest asset values for single- and multiple-species forest stands under uncertainty.

As used herein, a “forestry optimization model” (or “machine learning/artificial intelligence optimization model”) refers to any model that uses one or more machine learning operations to predict a measure of forest development and associated value based on information comprising forest information, or that is trained on information comprising forest information, including a predicted measure of forest worth and a sequence of harvesting operations that, when performed, is expected to produce the predicted goal.

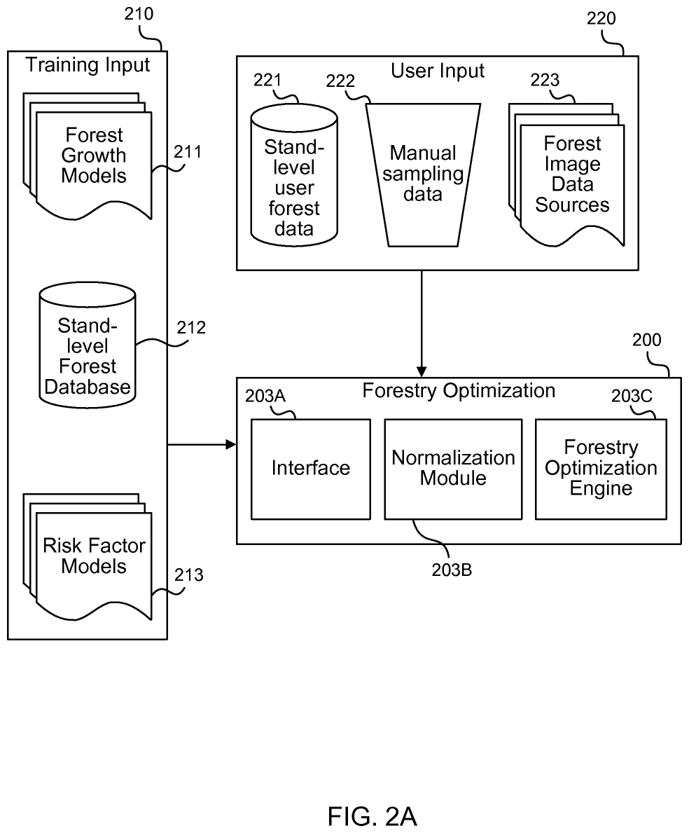

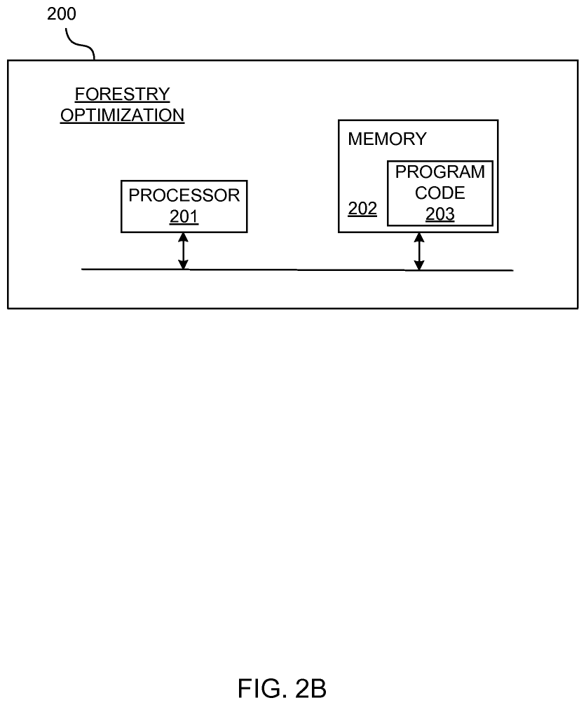

FIG. 2A is a block diagram of an apparatus 200 and its training input data sets 210 (including, e.g., forest growth models 211, stand-level forest data 212, and/or risk factor models 213) and user input data sets 220 (including, e.g., stand-level user forest data 221, manual sampling data 222, and/or forest image data 223), in accordance with an example embodiment. At least in some embodiments, the apparatus 200 may comprise one or more processors 201 and one or more memories 202 that comprise computer program code 203, as shown in FIG. 2B. The apparatus 200 may also include other elements not shown in FIGS. 2A and 2B.

At least in some embodiments, the apparatus 200 may further comprise an interface 203A, a normalization module 203B, and/or a forestry optimization engine 203C. At least one of the interface 203A, the normalization module 203B, or the forestry optimization engine 203C may be included in the computer program code 203.

The apparatus 200 may utilize various interfaces to interact with a requesting entity, such as a user. In an embodiment, the apparatus 200 may remain entirely separate from the requesting entity who is sending the input data to a human operator who performs the optimization and returns the results to the requesting entity. In another embodiment, the apparatus 200 is cloud-based and provides the requesting entity with some online interface through which data can be uploaded, and results can be returned. Other embodiments may include automated reports.

Although the apparatus 200 is depicted to include only one processor 201, the apparatus 200 may include more processors. In an embodiment, the memory 202 is capable of storing instructions, such as an operating apparatus 200 and/or various applications. Furthermore, the memory 202 may include a storage that may be used to store, e.g., at least some of the information and data used in the disclosed embodiments.

Furthermore, the processor 201 is capable of executing the stored instructions. In an embodiment, the processor 201 may be embodied as a multi-core processor, a single core processor, or a combination of one or more multi-core processors and one or more single core processors. For example, the processor 201 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 201 may be configured to execute hard-coded functionality. In an embodiment, the processor 201 is embodied as an executor of software instructions, wherein the instructions may specifically configure the processor 201 to perform the algorithms and/or operations described herein when the instructions are executed.

The memory 202 may be embodied as one or more volatile memory devices, one or more non-volatile memory devices, and/or a combination of one or more volatile memory devices and non-volatile memory devices. For example, the memory 202 may be embodied as semiconductor memories (such as mask ROM, PROM (programmable ROM), EPROM (erasable PROM), flash ROM, RAM (random access memory), etc.).

The apparatus 200 may comprise any of various types of computing devices.

The apparatus 200 is configured to access a set of input data 220 related to a forest stand. More specifically, in at least some embodiments, the at least one memory 202 and the computer program code 203 may be configured to, with the at least one processor 201, cause the apparatus 200 to perform the accessing of the set of input data 220 related to the forest stand.

As used herein, the term “forest stand” refers to a uniform forest compartment or a basic unit in forest management. For example, the forest stand may comprise a single-species forest stand or a multiple-species forest stand. At least in some embodiments, the forest stand may comprise an even-aged forest stand (all the trees are roughly the same age) or an uneven-aged forest stand (trees of different ages).

For example, the set of input data 220 may comprise size data, species data, quantity data, and/or age data of trees in the forest stand.

The set of input data may further comprise image data 223 related to the trees in the forest stand. The image data 223 may comprise aerial/drone images of the trees in the forest stand. Alternatively/additionally, the image data 223 may comprise images of the trees in the forest stand obtained via terrestrial laser scanning, airborne laser scanning, manual field measurements, and/or satellite images, and/or field pictures.

The apparatus 200 is further configured to determine a forest management plan defining at least one forest management activity for the forest stand based on the accessed set of input data 220 and at least one forest management preference. More specifically, in at least some embodiments, the at least one memory 202 and the computer program code 203 may be configured to, with the at least one processor 201, cause the apparatus 200 to perform the determining of the forest management plan defining the at least one forest management activity for the forest stand based on the accessed set of input data 220 and the at least one forest management preference.

For example, forestry stakeholders may use forest management plans for their forest assets to achieve maximal utility based on at least one forest management preference.

For example, the at least one forest management activity may comprise an instruction to apply at least a thinning or a clearcut to the forest stand, or an instruction to wait, i.e., do nothing for the time being. The at least one forest management activity may further comprise a harvesting schedule for the forest stand. At least in some embodiments, the harvesting schedule may comprise a harvest target, a harvest timing, and/or a harvest intensity.

At least in some embodiments, the at least one forest management activity may further comprise a scenario-based carbon analysis for the forest stand and/or a scenario-based sustainability analysis for the forest stand.

For example, the at least one forest management preference may comprise maintaining biodiversity of the forest stand, improving carbon storage of the forest stand, maximizing timber (including, e.g., sawlog and/or pulpwood) revenue of the forest stand, and/or maximizing harvesting profit of the forest stand.

The determining of the forest management plan for the forest stand is performed by applying a parameterized policy (or a parameterized policy function) to the accessed set of input data 220. The parameterized policy has been trained via a machine learning process using a forest development related simulation model. In other words, the parameterized policy has been trained with a simulated environment that comprises the forest development related simulation model. In yet other words, optimal parameters of the parameterized policy are found via the machine learning process. At least in some embodiments, the parameterized policy or parameterized policy function may be expressed with a neural network.

For example, the forest development related simulation model may comprise a deterministic forest development related simulation model comprising a forestry growth model with no uncertainty factor model.

Alternatively/additionally, the forest development related simulation model may comprise a stochastic forest development related simulation model comprising a forestry growth model and an uncertainty factor model. For example, the uncertainty factor model may be based on a random tree factor, a weather factor, a natural disaster factor, and/or an economic risk factor (such as a timber price factor and/or an exchange rate factor).

For example, forest growth may be strongly influenced by weather, climate shocks, and irregular natural disasters, such as insects and forest fires. Fluctuations in timber prices, demand, and interest rates may further add economic uncertainty. These risk factors—both physical and economic—may become exacerbated by the long planning horizon that is inherent to forestry. Thus, at least in some embodiments, forest valuation and management may benefit from a stochastic approach that can incorporate the effect of numerous risk factors over a long-time horizon.

At least in some embodiments, the forest development related simulation model may further comprise an empirically estimated model for forest dynamics. For example, the forest dynamics may comprise diameter increment (or growth), mortality and/or natural regeneration of trees.

For example, the machine learning process may comprise a reinforcement learning (RL) process, an approximate dynamic programming process, or an evolutionary computation process.

In the following, various example embodiments of training inputs will be discussed. It is to be understood that the disclosure is not limited to these example embodiments. For example, while the following example embodiments and the related equations (1)-(31) use profit as a parameter, the disclosure is not limited to profit or profit maximization as a forest management preference. Additionally/alternatively, the forest management preference may include, e.g., maintaining biodiversity of the forest stand, improving carbon storage of the forest stand, and/or maximizing a per period economic output. For example, “gross profit” may be directly replaced with “per period economic output” in the following example embodiments and the related equations (1)-(31).

As shown in FIG. 2A, the apparatus 200 may use various data sources to train the forestry optimization engine 203C.

In an embodiment, the apparatus 200 may use size- and age-structured forest growth models that have been estimated from empirical forest stand-level data. The apparatus 200 may apply a nonlinear size-structured model for mixed stands that allows direct application of empirically estimated ecological and economic parameters, and a detailed description of stand structure.

Using predetermined parametrizations, it is possible to extend the model specification to allow for mimicking tree size differentiation and variation in regeneration by simulating residual variation in diameter increment and ingrowth.

The stochastic formulation of the problem may build, e.g., on the following deterministic formulation.

Let the number of trees (per hectare (ha)) of species j=1, . . . , l in size classes s=1, . . . , n, at the beginning of period t, be denoted by x_{j,s,t}=(x_{j,1,t}, . . . , x_{j,n,t})∈ [symbol] ⁿ. Thus, at any time index t, the stand state is given by matrix xₜ∈ [symbol] ^{l×n} showing the number of trees in different species and size classes, respectively. During each period t, the fraction of trees of species j that move from size class s to the next size class s+1 is denoted by 0≤α_{j,s}(xₜ)≤1. Similarly, the fraction of trees that die during period t is given by 0≤μ_{j,s}(xₜ)≤1. The fraction of trees of species j that remain in the same size class during period t equals 1−α_{j,s}(xₜ)−μ_{j,s}(xₜ)≥0. Natural regeneration of species j is represented by the ingrowth function ϕⱼ with stand state xₜ as its argument.

Let Δ denote the period length (e.g., 5 years), r the interest rate per annum, and b^{Δ}=1/(1+r)^{Δ} the discount factor. The amount of harvested trees at the end of each time period is given by h_{j,s,t}, j=1, . . . , l, s=1, . . . , n, t=t₀, t₀+1, . . . , T, where T is the length of rotation and t₀ is the time needed for artificial regeneration of trees after a clearcut. This formulation assumes that the initial state is a bare land (does not need to be though). The gross revenues from clearcut and thinning are denoted by R_{cc}(h_{T}) and Rₜₕ(hₜ), and the corresponding variable clearcut and thinning costs are C_{cc}(h_{T}) and Cₜₕ(hₜ), respectively. A fixed harvesting cost C_{ƒ} (planning and transporting the harvester to the site) is also included, implying that harvesting may not be carried out at every period. To indicate the periods where harvesting takes place, binary variables δₜ∈{0,1} may be introduced such that δₜ=1 when harvesting h_{j,s,t}>0 takes place and a fixed harvesting cost occurs. Otherwise, δₜ=0 when harvests as well as harvesting costs are zero. Gross profits from thinning and clearcut may then be given by πₜₕ(hₜ)=Rₜₕ(hₜ)−Cₜₕ(hₜ)−δₜC_{ƒ} and π_{cc}(h_{T})=R_{cc}(h_{T})−C_{cc}(h_{T})−δ_{T}C_{ƒ}, respectively. Denoting the bare land value by J and the (present value) cost of artificial regeneration by w, the optimization problem for a mixed-species stand may be presented as:

$${max}_{{h}_{j , s , t} , {δ}_{t} , T ∈ [ {t}_{0} , ∞ )} J = \frac{- w + {\sum }_{t = {t}_{0}}^{T - 1} {π}_{th} ( {h}_{t} ) {b}^{Δ ( t + 1 )} + {π}_{cc} ( {h}_{T} ) {b}^{Δ ( T + 1 )}}{1 - {b}^{Δ ( T + 1 )}} \qquad ( 1 )$$

$$subject to : \\ {x}_{j , 1 , t + 1} = {ϕ}_{j} ( {x}_{t} ) + [ 1 - {α}_{j , 1} ( {x}_{t} ) - {μ}_{j , 1} ( {x}_{t} ) ] {x}_{j , 1 , t} - {h}_{j , 1 , t} , \\ j = 1 , … , l , \\ t = {t}_{0} , … , T \qquad ( 2 )$$

$${x}_{j , s + 1 , t + 1} = {α}_{j , s} ( {x}_{t} ) {x}_{j , s , t} + [ 1 - {α}_{j , s + 1} ( {x}_{t} ) - {μ}_{j , s + 1} ( {x}_{t} ) ] {x}_{j , s + 1 , t} - {h}_{j , s + 1 , t} , \\ j = 1 , … , l , s = 1 , … , n - 1 , t = {t}_{0} , … , T \qquad ( 3 )$$

$${h}_{j , s , t} = {δ}_{t} {h}_{j , s , t} , j = 1 , … , l , s = 2 , … , n , t = {t}_{0} , … , T , \qquad ( 4 )$$

$${x}_{j , s , {t}_{0}} given , j = 1 , … , l , s = 1 , … , n . \qquad ( 5 )$$

In addition, δt∈{0,1} and x_{j,s,t}, h_{j,s,t}≥0 for all j=1, . . . , l, s=1, . . . , n, t=t₀, . . . , T and x_{j,s,T+1}=0, j=1, . . . , l, s=1, . . . , n may hold. The equations (2) and (3) represent the development of the mixed-species stand, and species interaction arises via the stand density.

In this formulation, an optimal choice between RF and CCF may be determined by choosing the rotation period T. If the optimal rotation is infinitely long, the regime is CCF, otherwise for finite T, the regime is RF. This choice may depend, e.g., on tree species, interest rate and the cost of artificial regeneration. The equations (1)-(5) are designed for situations where the difference between CCF and RF is that the latter includes clearcut and artificial regeneration while the former does not.

Next, a stochastic size-structured optimization problem with varying initial states is introduced.

The model of equations (1)-(5) may be extended by incorporating, e.g., stochastic stand growth and the risk of sudden natural disasters, such as forest fire, windthrow and insect outbreaks. In comparison to the deterministic formulation, this may lead to several changes in the model specification. First, the state matrix xₜ is now stochastic. Second, the ingrowth function ϕⱼ and diameter increment function am are also stochastic based on a detailed ecological growth model. Third, the possibility of natural disasters that essentially clear the stand to a bare land such that artificial regeneration is needed in the same way as after a planned clearcut, is included.

Including stochasticity may result in relaxing the assumption of optimizing an infinite chain of rotations with perfectly equivalent management actions. Related to this, the apparatus 200 may specify a model for any initial stand structure and present new results on how the stand state determines the choice between clearcuts and harvests that avoid costly regeneration investment and that maintain the forest cover continuously. Also, including stochasticity and any initial stand state may result in the introduction of auxiliary variables for the stand state at the end of each period after growth but before harvest to allow utilizing the per period information on growth stochasticity as well as harvesting immediately at the initial state.

In the presence of uncertainty, the forest management problem may be viewed as an objective to maximize the expected net present value of harvesting profits over an infinite horizon. To include the possibility of varying rotation period length over time, Boolean variables δₜ^{th}∈{0,1} and δₜ^{cc}∈{0,1} may be defined to indicate periods when a thinning or a clearcut is planned to take place, respectively. The occurrence of a natural disaster is indicated by δₜ^{dis}. The forest stand state is reset to bare land denoted by x_{BL} whenever a clearcut or a disaster has occurred. The possible net salvage value of the stand after a natural disaster may be included in the parameter of artificial regeneration cost, but it is assumed that the salvage value is zero. To indicate a need for an artificial regeneration, a Boolean variable δₜ^{reg} may be introduced, which takes a value of 1 if clearcut or a natural disaster has taken place at time t. This formulation uses xₜ to represent the stand state right before harvesting takes place and introduces an auxiliary variable \tilde{x}ₜ to denote the stand state after the harvesting has taken place. If there is no harvesting during the given period, the auxiliary variable takes the same value as the stand state variable xₜ. Denoting the value of a given initial state x by J(x) and per period gross profit by π, the stochastic optimization problem for a mixed-species stand may then be presented as:

$${max}_{{h}_{t} , {δ}_{t}^{th} , {δ}_{t}^{cc}} J ( x ) = 𝔼 [ {\sum }_{t = 0}^{∞} π ( {x}_{t} , {h}_{t} , {δ}_{t}^{th} , {δ}_{t}^{cc} ) {b}^{Δ t} ] \qquad ( 6 )$$

$$subject to : \\ {\tilde{x}}_{j , s , t + 1} = ( {x}_{j , s , t} - {h}_{j , s , t} {δ}_{t}^{th} ) ( 1 - {δ}_{t}^{cc} ) , \\ j = 1 , … , l , s = 1 , … , n - 1 , t = 0 , 1 … , \qquad ( 7 )$$

$${x}_{j , 1 , t + 1} = ( {ϕ}_{j} ( {\tilde{x}}_{t} , {ω}_{t} ) + [ 1 - {α}_{j , 1} ( {\tilde{x}}_{t} , {ε}_{t} ) - {μ}_{j , 1} ( {\tilde{x}}_{t} ) ] {\tilde{x}}_{j , 1 , t} ) ( 1 - {δ}_{t}^{reg} ) ( 1 - {δ}_{t - 1}^{reg} ) + ( 1 - {δ}_{t}^{reg} ) {δ}_{t - 1}^{reg} {x}_{j , 1 , BL} , j = 1 , … , l , t = 0 , 1 … , \qquad ( 8 )$$

$${x}_{j , s + 1 , t + 1} = ( {α}_{j , k} ( {x}_{t} , {ε}_{t} ) {\tilde{x}}_{j , s , t} + [ 1 - {α}_{j , s + 1} ( {\tilde{x}}_{t} , {ε}_{t} ) - {μ}_{j , k + 1} ( {\tilde{x}}_{t} ) ] {\tilde{x}}_{j , s + 1 , t} ) ( 1 - {δ}_{t}^{reg} ) ( 1 - {δ}_{t - 1}^{reg} ) + [ ( 1 - {δ}_{t}^{reg} ) {δ}_{t - 1}^{reg} ] {\tilde{x}}_{j , s + 1 , BL} , j = 1 , … , l , s = 1 , … , n - 1 , \qquad ( 9 )$$

$${δ}_{t}^{reg} = \{ \begin{matrix}1 & if {δ}_{{t}^{′}}^{cc} = 1 or {δ}_{{t}^{′}}^{dis} = 1 for some {t}^{′} ∈ \{ t - {t}_{d} , … , t \} \\ 0 & otherwise\end{matrix} \qquad ( 10 )$$

$${δ}_{t}^{th} {δ}_{t}^{cc} = 0 , t = 0 , 1 , … , ∞ , \qquad ( 11 )$$

$${x}_{j , s , 0} = {\tilde{x}}_{j , s , init} , t = 0 , 1 , … , ∞ \qquad ( 12 )$$

$${\tilde{x}}_{t} , {h}_{t} \geq 0 , t = 0 , 1 , … , ∞ ,$$

where the decision variables may include the number of harvested trees of species j from size class s, h_{j,s,t}, and the indicator variables δₜ^{th} and δₜ^{cc} that determine the timings for thinning and clearcuts, respectively. The stochastic variation in diameter increment and ingrowth are denoted by εₜ and ωₜ, respectively. The per period gross profit may be defined as:

$$π ( {x}_{t} , {h}_{t} , {δ}_{t}^{h} , {δ}_{t}^{cc} ) = \{ \begin{matrix}{R}_{th} ( {h}_{t} ) - {C}_{th} ( {h}_{t} ) - {C}_{f} & \begin{matrix}if {δ}_{t}^{th} = 1 and \\ {δ}_{t}^{dis} = 0\end{matrix} \\ {R}_{cc} ( {x}_{t} ) - {C}_{cc} ( {x}_{t} ) - {C}_{f} - w & if {δ}_{t}^{cc} = 1 \\ - w & if {δ}_{t}^{dis} = 1 \\ 0 & otherwise\end{matrix} . \qquad ( 13 )$$

The equations (8) and (9) may now represent stochastic ecological growth dynamics. As a difference to the dynamics considered in the deterministic model, the indicator variable δₜ^{reg} defined by equation (10) may be used to adjust the stand state for the occurrence of clearcuts and natural disasters that occur at dates t_{d}, d=1, 2, . . . , ∞. The occurrence of natural disasters may be modelled as Bernoulli distributed random variables. The stand state after harvests may be given by equation (7). The remaining equation (11) is a complementarity condition stating that the indicator for a clearcut δₜ^{cc} may have a value of 1 if thinning does not take place, and vice versa.

Next, ecological growth models are introduced. Specifically, the growth functions α_{j,s}, μ_{j,k} and ϕⱼ for each species j=1, . . . , l are presented.

Let parameters b_{0,j}, . . . , b_{25,j} denote the species-specific regression coefficients. First, a mortality function may be given by:

$${μ}_{j , s} ( {x}_{t} ) = 1 - [ 1 + exp ( - {b}_{0 , j} - {b}_{1 , j} \sqrt{{d}_{s}} - {b}_{2 , j} {d}_{s} - \qquad ( 14 )$$

$${b}_{3 , j} \sqrt{{B}_{s , pine} ( {x}_{t} )} - {b}_{4 , j} \sqrt{{B}_{s , spruce} ( {x}_{t} )} - {b}_{5 , j} \sqrt{{B}_{s , birch} ( {x}_{t} ) + {B}_{s , aspen} ( {x}_{t} )} -$$

$${{b}_{6 , j} \sqrt{{B}_{s , birch} ( {x}_{t} ) + {B}_{s , aspen} ( {x}_{t} ) + {B}_{s , pine} ( {x}_{t} )} - {b}_{7 , j} Period ) ]}^{- 1} ,$$

where B denotes the stand basal area (m²ha⁻¹) and Bₛ is the basal area for trees with diameters larger than in size class s. The size classes s=1, . . . , n are measured by mean diameter at breast height dₛ from 2.5 cm to 52.5 cm in 5 cm intervals, for example. The functions B_{s,j}, j=1, . . . , l represent the basal area in larger pine, spruce, birch and aspen (for example) size classes, respectively.

To specify the fraction α_{j,k} of trees that move to the next size class during the next 5-year (for example) period, the formulation may convert the singletree diameter increment models into a transition matrix model by dividing diameter growth with the width of the size class k, i.e. α_{j,s}(xₜ)=k⁻¹(l_{j,s}(xₜ)), s=1, . . . , n, where l_{j,s}(xₜ) is the diameter growth in size class s for species j=1, . . . , l. Hence, the fractions of trees that move to the next size class during the next 5-year period may be given by:

$${α}_{j , s} ( {x}_{t} , {ε}_{t} ) = {k}^{- 1} ( exp ( {b}_{8 , j} + {b}_{9 , j} \sqrt{{d}_{s}} + {b}_{10 , j} {d}_{s} + {b}_{11 , j} ln ( TS ) + \qquad ( 15 )$$

$${b}_{12 , j} ln ( B ( {x}_{t} ) ) + {b}_{13 , j} \frac{{B}_{s , pine} ( {x}_{t} )}{\sqrt{{d}_{s} + 1}} + {b}_{14 , j} \frac{{B}_{s , spruce} ( {x}_{t} )}{\sqrt{{d}_{s} + 1}} +$$

$${b}_{15 , j} \frac{{B}_{s , birch} ( {x}_{t} ) + {B}_{s , aspen} ( {x}_{t} )}{\sqrt{{d}_{s} + 1}} + {b}_{16 , j} SD + {b}_{17 , j} {d}_{s} SD + {b}_{18 , j} Aspen ) + {ε}_{j , s , t} ) ,$$

where, in order to meet restrictions 0≤α_{j,s}(xₜ)≤1 −μ_{j,s}(xₜ)≤1, the interpretation α_{j,s}(xₜ, εₜ)=0 may be used when the right-hand-side is less than zero and α_{j,s}(xₜ)=1−μ_{j,s}(xₜ) may be used when the right-hand side is above 1 −μ_{j,s}(xₜ).

Variable TS is the temperature sum of the stand, which in this example may be set, e.g., at 1100, to represent the climate of central Finland. This diameter growth specification is given for average fertile site but may be generalized to other site types as well. The last term εⱼₖₜ captures the stochastic variation around the expected diameter increment. This is obtained by aggregating the residual variation from a tree-level model that consists of a tree-specific intercept and an auto- and cross-correlated residual. Under the assumption of no tree-specific trends, the deviations from the model predictions may then be given by:

$${ε}_{j , s , t , i} = {a}_{i} + {v}_{i , t} with {v}_{i , t} = {ρ}_{j} {v}_{i , t - 1} + {e}_{i , t} , {e}_{t} = ( {e}_{1 , t} , … , {e}_{{N}_{j , k} , t} ) ∼ N ( 0 , {\sum }_{e} ) , \qquad ( 16 )$$

where aᵢ denotes a random tree factor for tree i of species j in size-class s, N_{j,s} is the number of trees of species j in size-class s, v_{i,t} is a random autocorrelated residual for tree i and 5-year period t, and ρⱼ is the species-specific correlation coefficient of the residuals from consecutive 5-year periods. The tree specific factor accounts from ⅓ to ½ of the unexplained variation and the rest is due to autocorrelated residuals. The strength of autocorrelation in residuals may be between 0.4 and 0.7 on annual level, and the correlation between 5-year residuals may be roughly half of this. Given that the annual variation may depend on weather conditions that are the same for all trees, the random factors e_{i,t} are typically cross-correlated across trees. The cross-correlation of residuals is assumed to be around 0.3 in this example.

The ingrowth function representing natural regeneration during the 5-year period may be defined as the product of the probability of ingrowth and the number of ingrowth trees. Let N_{in,j} and p_{in,j} denote the number of ingrowth trees and the probability of ingrowth, respectively. A stochastic extension of an ingrowth function may then be given by:

$$\begin{matrix}{ϕ}_{j} ( {x}_{t} , {ω}_{t} ) = {N}_{in , j} \times {p}_{{in}_{{j}^{′}}} \\ {N}_{in , j} = exp ( {b}_{19 , j} + {b}_{20 , j} \sqrt{B ( {x}_{t} )} + {b}_{21 , j} ln ( {B}_{birch} ( {x}_{t} ) ) + \\ {b}_{22 , j} B ( {x}_{t} ) + {ω}_{j , t} ) , \\ {p}_{in , j} = \frac{1}{\begin{matrix}1 + exp ( - {b}_{23 , j} - {b}_{24 , j} ln ( {B}_{j} ( {x}_{t} ) ) - {b}_{25 , j} \sqrt{{B}_{pine} ( {x}_{t} )} - \\ {b}_{26 , j} {B}_{pine} ( {x}_{t} )\end{matrix}} - \\ {b}_{27 , j} B ( {x}_{t} ) )\end{matrix} , \qquad ( 17 )$$

$${ω}_{j , t} = {ρ}_{j} {ω}_{j , t - 1} + {u}_{j , t} , {u}_{t} = ( {u}_{1 , t} , … , {u}_{l , t} ) \sim N ( 0 , {\sum }_{u} ) \qquad ( 18 )$$

where ω_{j,t} denotes the residual variation in ingrowth for species j and 5-year period t. The relative growth variation may be large especially among small trees and in the ingrowth estimates. The ingrowths of consecutive 5-year periods and the residuals of predicted ingrowths may be positively correlated. The species-specific temporal autocorrelation coefficient is given by ρⱼ. This is largely explained by the fact that one good regeneration year tends to generate ingrowth for several years. In addition to autocorrelation, the residuals of predicted ingrowths may be cross-correlated across species, which is captured by the random factors u_{j,t} that are assumed to follow a multivariate normal distribution. In another example, the apparatus 200 may be trained directly on empirical forest stand-level data without using pre-existing growth models. In yet another example, the apparatus 200 may be trained on a combination of forest growth models and empirical forest data.

In addition, the apparatus 200 may incorporate empirically estimated dynamics for various natural phenomena, including—but not limited to—forest fires, wind, and/or insects.

The extent of boreal forest disturbance regimes may range from succession following stand-replacing disturbances, such as severe fires, wind-storms, and insect outbreaks, to small-scale dynamics associated with gaps in the canopy created by the loss of individual trees. However, the apparatus 200 may use a formulation that allows comparison of results and that captures only large scale, stand-replacing disturbances which may be included without the need for adjusting the equations defining the stand state dynamics.

To include the risk of natural disasters, the stochastic indicator variable δₜ^{dis} may be introduced into the model through equation (10). If δₜ^{dis}=1, a disaster has occurred during time step t, and all the trees are lost. A regeneration cost takes place at the end of the period t. The forest stays empty for the next t₀ periods, after which the state is set to the bare land initial state as specified in the last terms of equations (8) and (9). For simplicity, the stochastic indicator variables δₜ^{dis} may be modelled as independent and identically distributed (i.i.d.) Bernoulli distributed random variables with parameter p_{dis}, which is the probability of a disaster occurring during a period of Δ years.

In an example, the apparatus 200 may use the following economic parameter values. Trees may be divided into 11 size classes s=1, . . . , 11, measured by diameter at breast height dₛ, ranging from 2.5 cm to 52.5 cm (midpoint) in 5 cm intervals. Each size class may have species-specific volumes for both sawtimber v_{1,s,j} and pulpwood v_{2,s,j} as well as corresponding species-specific roadside prices for sawtimber p_{1,j} and pulpwood p_{2,j}. Harvesting revenues may then be defined separately for sawtimber and pulpwood using species-specific market prices. The gross revenue per period may be given by:

$$R ( {h}_{t} ) = {\sum }_{j = 1}^{l} {\sum }_{s = 1}^{n} ( {p}_{1 , j} {v}_{1 , j , s} + {p}_{2 , j} {v}_{2 , j , s} ) {h}_{j , s , t} . \qquad ( 19 )$$

In this example, the prices are assumed to be deterministic. Other examples may include stochastic prices.

The harvesting costs may depend on, e.g., species, tree diameter and the quantity of wood harvested. The variable harvesting and hauling costs may be derived for both clearcut q=cl and thinning q=th as:

$${C}_{q} ( {h}_{t} ) = {\sum }_{j = 1}^{l} {c}_{j , q , 0} {\sum }_{s = 1}^{n} {h}_{j , s} ( {c}_{j , q , 1} + {c}_{j , q , 2} {v}_{j , s} + {c}_{j , q , 3} {v}_{j , s}^{2} ) \qquad ( 20 )$$

$$+ {c}_{q , 4} {\sum }_{j = 1}^{l} {\sum }_{s = 1}^{n} {h}_{j , s} {v}_{j , s} + {{c}_{q , 5} ( {\sum }_{j = 1}^{l} {\sum }_{s = 1}^{n} {h}_{j , s} {v}_{j , s} )}^{0.7} , q = t h , c l , \qquad ( 21 )$$

where v_{j,s} is the total tree volume, and c_{j,q,s} are parameters. The model may define cutting (20) and hauling (21) costs separately. According to this model, the variable harvesting costs may increase with total harvested volume but decrease with tree volume. Cutting costs may have species-specific parameters, while hauling costs may be determined without separating between tree species. Cutting costs per tree may be higher for thinning than clearcut as c_{j,th,0}>c_{j,cl,0} for all species. It is also assumed that the smallest size class (with diameter at breast height at 2.5 cm) may only be harvested during a clearcut.

In an example, the fixed harvesting cost parameter C_{ƒ} may be set to €500 ha⁻¹. The fixed cost may include both a harvest operation planning cost and the cost of transporting the logging machinery to the site. The (present value) cost of artificial regeneration denoted by w is may be set to €1489 ha⁻¹ and €1401 ha⁻¹ for 1% and 3% interest rates, respectively. The regeneration cost parameter may include, e.g., ground mounding at year zero (€377 ha⁻¹), planting at year one (€739 ha⁻¹), and tending of the seedling stand at year 11 (€424 ha⁻¹).

In the following, various example embodiments of model training will be discussed. It is to be understood that the disclosure is not limited to these example embodiments.

Decision-making problems under uncertainty are known for being considerably harder to solve than their deterministic counterparts. When considering infinite-horizon problems where each action (harvesting decision) depends only on the most recently observed state (forest stand state and market prices), one approach is to treat them as Markov decision processes (MDP). The Markov process theory is particularly convenient when the number of possible states as well as actions are both finite. Specifically, many such decision processes may be solved efficiently using linear programming (LP) formulations. However, the stochastic size-structured optimization problem discussed in above has infinitely many states and actions. While this means that the classic LP formulation cannot be maintained, it offers the benefit of being able to include, e.g., detailed nonlinear stand growth and harvesting cost models, optimization of harvest timing, and the choice between continuous cover and rotation forestry.

To solve the optimization problem defined by the dynamic decision process, algorithms that are able to work with continuous state and action spaces may be used. While dynamic programming approaches may be effective for handling problems with limited number of states and actions, the formulations still become intractable if the number of states and actions is allowed to be infinite. To overcome these challenges, at least in some embodiments, the disclosure may use a reinforcement learning (RL) algorithm that combines simulation-based learning with compact representations of policies and value functions.

The forest related size-structured stochastic optimization problem presented earlier may be framed as a task that may be approached using reinforcement learning techniques.

Reinforcement learning is an actively researched branch of machine learning with deep roots in psychological and neuroscientific views of how agents may optimize their control of an environment. The underlying theory has connections to dynamic programming and the use of Bellman optimality principles. In RL, the agent (or model) learns by interacting with its environment and gathering experience that will help the agent to evaluate what was successful and find out what could be the optimal actions in different situations. The interaction between a learning agent and its environment may be defined using the formal framework of Markov decision processes, but as a difference to dynamic programming, its exact mathematical form does not necessarily need to be known. The environment is commonly defined as a large simulation model representing how the actual environment would respond to the actions taken by the agent.

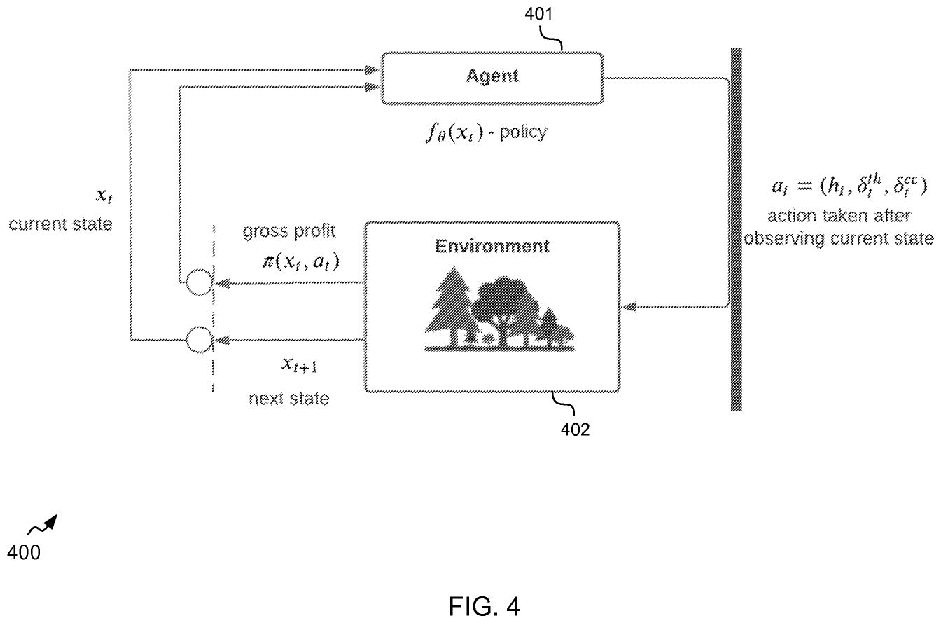

In this disclosure, the mathematical representation of the environment simulator may be given, e.g., by the set of constraint equations (7)-(12) defining the dynamics of the stochastic growth model, as illustrated in diagram 400 of FIG. 4. The agent 401 may be seen as a decision maker that makes forest management decisions by following a deterministic, stationary policy function that maps the observed forest stand states into actions. The stochastic size-structured optimization problem may correspond to a dynamic decision model, where the optimal value J(x) may be achieved by following a deterministic stationary policy. The existence of a deterministic stationary policy may be seen as equivalent to the existence of a function ƒ_{θ}:X→A that maps a given forest stand state to a corresponding optimal harvesting decision, where the form of the function does not change over time. Here, X denotes the set of all possible forest stand states and A is the set of all admissible actions a=(h, δ^{th}, δ^{cc})∈A that are feasible subject to the model constraints. As illustrated in FIG. 4, the agent 401 and the environment 402 may interact at discrete time steps t=0, 1, 2, . . . . At each time step t, the agent 401 may receive a description of the forest stand state xₜ, and on that basis may select an action aₜ=(hₜ, δₜ^{th}, δₜ^{cc}) where the agent 401 may choose between, e.g., thinning, clearcut and doing nothing, and if thinned how much. As a consequence of its action, the agent 401 may receive a reward, per period gross profit, π(xₜ, aₜ)=π(xₜ, hₜ, δₜ^{h}, δₜ^{cc}) as defined by equation (13), and observe a new stand state xₜ₊₁ one time step later. The Markov decision process underlying the environment 402 and the agent 401 together may thereby give rise to a trajectory of states, forest management decisions and gross profits: x₀, a₀, π₀, x₁, a₁, π₁, . . . . In RL, each of these trajectories may begin independently of how the previous one ended. Since the objective of the agent 401 may include maximizing, e.g., the expected NPV of gross profit over each trajectory, the agent 401 may learn from the rewards that it has received by pursuing different forest management policies as represented by the sequence of actions it has taken. The term learning thereby may refer to the process of how the agent 401 uses trajectory data to update the parameters of its policy function ƒ_{θ} that effectively represents a solution to the original stochastic size-structured optimization problem. Reinforcement learning methods may thus be understood as mechanisms that specify how the agent's policy is changed as a result of its experience.

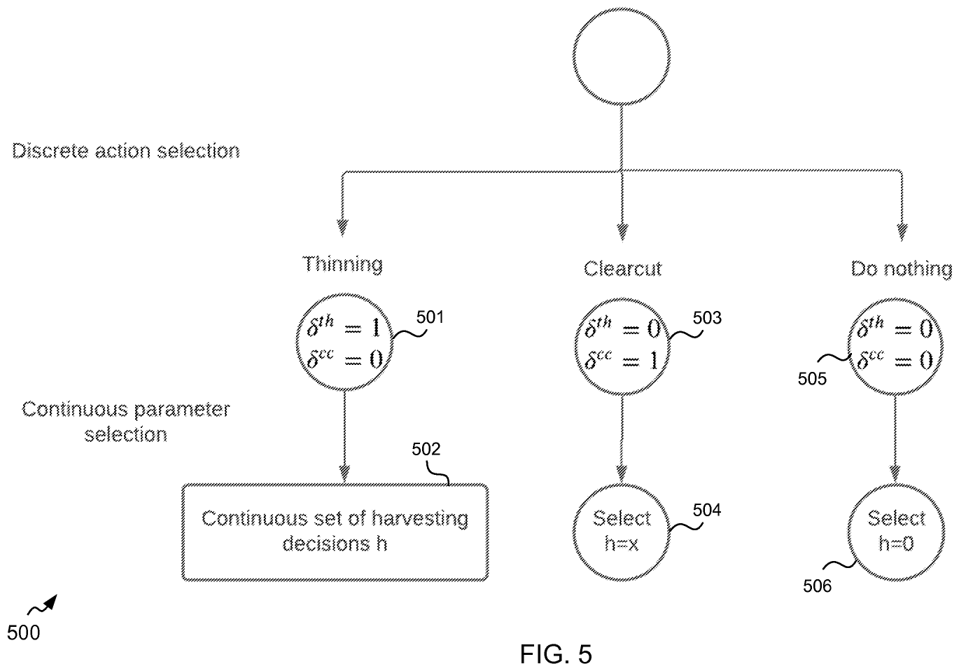

The performance of RL algorithms may be affected by the cardinality of the action space (set of all admissible harvesting decisions) and state space (set of all possible forest stand states). To solve the stochastic optimization problem, an algorithm may be used that allows a mixture of continuous (harvesting amounts) as well as discrete actions (timings of clearcuts and thinnings). In this disclosure, the problem of continuous action and state space may be approached, e.g., by using a notion of parameterized action spaces. The idea is to view the overall action as a hierarchical structure instead of a flat set. As shown in diagram 500 of FIG. 5, each action may be decomposed into, e.g., two layers. The first layer may be a discrete action of choosing between thinning 501, clearcut 503 and doing nothing 505. The second layer may then choose the parameters corresponding to each discrete action type 502, 504 or 506 coming from the first layer. In the context, the parameters may represent the actual harvesting amounts that are defined as continuous real-valued variables.

To handle the parameterized action space containing both discrete actions and continuous parameters, a hybrid proximal policy optimization (H-PPO) algorithm may be used, for example. The implementation of the algorithm may be based on a broadly applied actor-critic framework. To this end, e.g., two components may be specified in this disclosure: (1) an “actor” function, which the agent 401 may use as its current policy to approximate the unknown optimal policy ƒ_{θ}, and (2) a “critic” function, which may help the agent 401 to estimate the advantage (benefit) of using the current policy and thereby update the actor's policy parameters in the direction of performance improvement indicated by the critic. The H-PPO algorithm may be considered as an implementation of stochastic gradient algorithm on the parameter space of stationary policies.

Since the actor function may be used to approximate the unknown optimal policy, the function may be flexible enough to represent a sufficiently large class of stationary policies. Furthermore, to enable the agent 401 to explore the benefits of performing different types of actions, it may be assumed that the actor function is not deterministic but a conditional probability density q_{θ}(a|x) over the set of all feasible actions a∈A given the current forest stand state x. Since each action a=(h, δ^{th}, δ^{cc}) may comprise continuous and discrete variables, the joint density q_{θ}(δ^{th}, δ^{th}, δ^{cc}|x) may be expressed as a product of discrete and continuous densities denoted by q_{θ,d}(δ^{th}, δ^{cc}|x) and q_{θ,c}(h|x), respectively. The objective of the H-PPO algorithm may thus be to find parameters θ such that the corresponding parameterized policy q_{θ} generates episodes that maximize the expected NPV, i.e.:

$${θ}^{*} ∈ {arg max}_{θ} {𝔼}_{{q}_{θ}} [ {\sum }_{t = 0}^{∞} π ( {x}_{t} , {a}_{t} ) {b}^{Δ t} ] , \qquad ( 22 )$$

where the expectation may be taken under the assumption that the harvesting actions are chosen using the actor probability distribution q_{θ}. To use a policy gradient theorem and stochastic gradient ascent to learn the parameters, it may further be assumed that the parametric stochastic policies q_{θ} may be differentiable. To ensure that the approximations also have sufficient representative abilities, they may be implemented using, e.g., neural networks as function approximators, which may be seen as a standard approach in reinforcement learning applications.

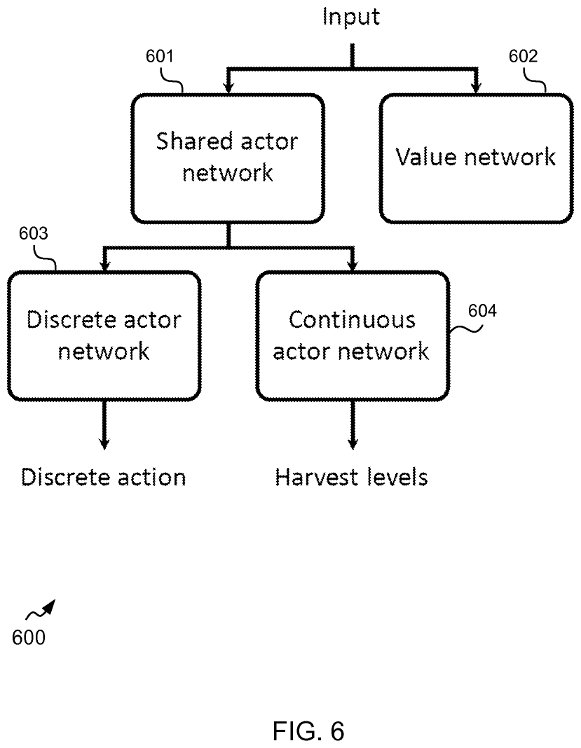

At least in some embodiments, separate networks for discrete and continuous actions may be used. In an example, the networks may be feedforward neural networks. The continuous and discrete actors may share the first layers. Diagram 600 of FIG. 6 illustrates this. The shared actor network 601 may have an input layer (dimension matches the input) and an output layer with a dimension 500 (for example). A rectified linear unit (ReLU) may be used as an activation function for both layers. The discrete actor network 603 may have an input layer (e.g., dimension 500) followed by a hidden layer of dimension 200. The output layer may have, e.g., three nodes, as there are three discrete actions. The activation functions may be, e.g., ReLUs, except for the output layer, where a softmax function may be used to get logit numbers. The continuous actor network 604 may have the same dimensions as the discrete actor network 603, except that the output layer may have a dimension and the output activation may be linear. The value network 602 used in the critic-part of the algorithm may be a separate network, with hidden layers of sizes 500, 300 and 200 (for example). The activation function may be, e.g., a ReLU. The network structures may be different in other examples.

Next, the “critic” is described, which has a role in helping to reduce the variance in the estimated policy gradients while still allowing the estimates to remain unbiased. To reduce the variance for sampled rewards (e.g., gross profits), the sum of discounted gross profits in the objective may be replaced with an advantage function:

A_{q}_{_{θ}}(xₜ,aₜ)=Q_{q}_{_{θ}}(xₜ,aₜ)−V_{q}_{_{θ}}(xₜ), (23)

where V_{q}_{_{θ}}(x)= [symbol] _{q}_{_{θ}}[Σₜ₌₀^{∞}π(xₜ, aₜ)b^{Δt}|x₀=x] is the state value function associated with policy q_{θ}, which may give the total expected NPV that is encountered while the policy is executed. In an actor-critic algorithm, such as H-PPO, the state value function may also be referred to as the critic function, which may be approximated using, e.g., a suitable parametric, differentiable function.

The function Q_{qθ}(x, a)= [symbol] _{q}_{_{θ}}[Σₜ₌₀^{T}(xₜ, aₜ)b^{Δt}|x₀=x, a₀=a] is the action-value function that assigns to the pair (x, a) the total expected NPV encountered when the decision process is started in state x, the first action is a while the subsequent actions are determined by the policy q_{θ}. The advantage function may be interpreted as the expected benefit of taking action aₜ in state xₜ. To find a policy with higher expected NPV, policy parameters θ may be updated in a direction where they lead to choose actions with positive advantage values.

To compute the advantages, the idea in actor-critic frameworks is to approximate the unknown state value function V_{qθ} using a parametric function V_{q}_{_{θ,ϕ}}:S→ [symbol] known as the critic. Herein, a neural network may be used as a critic function, which follows a structure similar to the approximator used to implement the actor function. While also the action-value function Q_{q}_{_{θ}} may be unknown, a separate function estimator need not be constructed, since the expressions for A_{qθ} may be simplified such that it is sufficient to know only the critic function to be able to compute the advantages. In practice, this may be done using, e.g., a generalized advantage estimation (GAE) function:

Âₜ^{GAE(b,λ)}=(1−λ)(Âₜ⁽¹⁾)+λÂₜ⁽²⁾+λ²Âₜ⁽³⁾+ . . . ) (24)

where the overall advantage may be expressed as a sum of 1 to k-step look-ahead functions:

$$\begin{matrix}{\hat{A}}_{t}^{( 1 )} = - V ( {x}_{t} ) + π ( {x}_{t} , {a}_{t} ) + bV ( {x}_{t + 1} ) \\ {\hat{A}}_{t}^{( 2 )} = - V ( {x}_{t} ) + π ( {x}_{t} , {a}_{t} ) + bV ( {x}_{t + 1} ) + {b}^{2} V ( {x}_{t + 2} ) \\ ⋮ \\ {\hat{A}}_{t}^{( k )} = - V ( {x}_{t} ) + π ( {x}_{t} , {a}_{t} ) + bV ( {x}_{t + 1} ) + … + {b}^{k - 1} V ( {x}_{t + k - 1} ) + {b}^{k} V ( {x}_{t + k} )\end{matrix} ,$$

where λ∈[0,1] is a hyper parameter. When λ=1, the estimation is known as a Monte Carlo approach. When λ=0, the definition corresponds to a temporal difference with one step look-ahead.

The policy gradient may be written as:

$${∇}_{θ} {𝔼}_{{q}_{θ}} [ {\sum }_{t = 0}^{∞} π ( {x}_{t} , {a}_{t} ) {b}^{Δ t} ] = {𝔼}_{{q}_{θ}} [ {\sum }_{t = 0}^{∞} {∇}_{θ} log {q}_{θ} ( {a}_{t} \vert {x}_{t} ) {A}_{{q}_{θ}} ( {x}_{t} , {a}_{t} ) ] \qquad ( 25 )$$

$$\approx {\hat{𝔼}}_{{q}_{θ}} [ {\sum }_{t = 0}^{T} {∇}_{θ} log {q}_{θ} ( {a}_{t} \vert {x}_{t} ) {\hat{A}}_{t}^{GAE ( b , λ )} ] , \qquad ( 26 )$$

where the expectation [symbol] _{q}_{_{θ}} denotes the empirical average over a finite batch of sample trajectories with T denoting the maximum length of an observed trajectory. In practice, the policy optimization may be carried out by, e.g., an iterative algorithm that alternates between sampling data from the policy and optimization, which essentially corresponds to a gradient ascent to update the policy parameters. The algorithm may be essentially similar to a proximal policy optimization (PPO) algorithm with slight modifications to allow for the use of parameterized actions that combine continuous and discrete decisions.

To implement the actor-critic framework for reinforcement learning in practice, proximal policy optimization with clipped surrogate objective (PPO-Clip) may be used at least in some embodiments. In PPO-Clip, the policy parameters may be updated via, e.g.:

$${θ}_{k + 1} = {arg max}_{θ} {𝔼}_{{q}_{{θ}_{k}}} [ L ( x , a , {θ}_{k} , θ ) ] , \qquad ( 27 )$$

where the surrogate objective L is defined as a sum of losses corresponding to the discrete and continuous decisions, i.e.

$$L ( x , a , {θ}_{k} , θ ) = {L}_{c} ( x , h , {θ}_{k , c} , {θ}_{c} ) + {L}_{d} ( x , {δ}^{th} , {δ}^{cc} , {θ}_{k , d} , {θ}_{d} ) \\ where a = ( h , {δ}^{th} , {δ}^{cc} ) , θ = ( {θ}_{c} , {θ}_{d} ) , and \qquad ( 28 )$$

$${L}_{c} ( x , h , {θ}_{k , c} , {θ}_{c} ) = min ( \frac{{q}_{{θ}_{c}} ( h \vert c )}{{q}_{{θ}_{k , c}} ( h \vert x )} {\hat{A}}^{GAE ( b , λ )} , g ( ϵ , {\hat{A}}^{GAE ( b , λ )} ) ) \qquad ( 29 )$$

$${L}_{d} ( x , {δ}^{th} , {δ}^{cc} , {θ}_{k , d} , {θ}_{d} ) = min ( \frac{{q}_{{θ}_{d}} ( {δ}^{th} , {δ}^{cc} \vert x )}{{q}_{{θ}_{k , d}} ( {δ}^{th} , {δ}^{cc} \vert x )} {\hat{A}}^{GAE ( b , λ )} , g ( ϵ , {\hat{A}}^{GAE ( b , λ )} ) ) \qquad ( 30 )$$

$$g ( ϵ , A ) = \{ \begin{matrix}( 1 + ϵ ) A & if A \geq 0 , \\ ( 1 - ϵ ) A & if A < 0\end{matrix} . \qquad ( 31 )$$

The clipping done in L works as a regularizer that penalizes changes to the policy that move the probability ratio away from 1. The hyperparameter ϵ corresponds to how far away the new policy may go from the old while still improving the objective. This approach may allow ensuring reasonable policy updates. The steps taken in the PPO-Clip algorithm may be outlined in pseudo-code, e.g., as follows:

```
procedure PPO-Clip
  Input: initial policy parameters θ₀, initial
  value function parameters ϕ₀
  for k = 0, 1, 2, . . . do
    Sample a set of trajectories Dₖ = {τᵢ} each
    with T timesteps by running policy q_{θ}_{ₖ} in
    the environment.
    Compute rewards to go Ûₜ = Σₜ₋ₜ^{T} π (xₜ, aₜ)b^{Δt}.
    Compute advantage estimates Âₜ^{GAE(b,λ)} based
    on the current value function V_{ϕ}_{ₖ}.
    Update the policy by maximizing the clipped
    surrogate objective:
      ${θ}_{k + 1} = {argmax}_{θ} \frac{1}{\vert {D}_{k} \vert T} {\sum }_{τ ∈ {D}_{k}} {\sum }_{t = 0}^{T} L ( {x}_{t} , {a}_{t} , {θ}_{k} , θ )$
    using (stochastic) gradient ascent.
    Estimate value function by minimizing
    mean-squared error:
      ${ϕ}_{k + 1} = {argmin}_{ϕ} \frac{1}{\vert {D}_{k} \vert T} {\sum }_{τ ∈ {D}_{k}} {\sum }_{t = 0}^{T} {( {V}_{ϕ} ( {x}_{t} ) - {\hat{U}}_{t} )}^{2}$
    using gradient descent.
  end for
end procedure
```

Once the apparatus 200 has been trained, it may be ready to receive a request to perform forest strategy optimization and/or asset valuation from a requesting entity (e.g., a forestry stakeholder). The requesting entity may provide the apparatus 200 with size-structured forest stand data. This data may essentially describe, e.g., how many trees of what species and/or size class are in the to-be-optimized forest plot.

If the data of the requesting entity has, e.g., insufficient granularity, the apparatus 200 may require additional inputs. In an embodiment, the input data may be supplemented with image data from various sources, including—but not limited to—drone footage and satellite images. In another embodiment, the input data may be supplemented with stand-level data from a manual onsite survey. In yet another embodiment, the size-/age-structured data may be approximated by using, e.g., a Weibull distribution.

The apparatus 200 may apply the learned optimal policy to the input from the requesting entity to find an optimal harvesting schedule and asset valuation for the specific forest stand composition. A solution may thereby be optimal in one or more dimensions based on the requesting entity's preferences, including—but not limited to—profit maximization, emission reductions, and/or biodiversity preservation.

Because the apparatus 200 may have been trained in a stochastic environment, it may output strategies that not only maximize the user-defined objective, but are also robust towards physical and economical uncertainty factors. Moreover, the apparatus 200 may choose between traditional rotation forestry and continuous cover forestry.

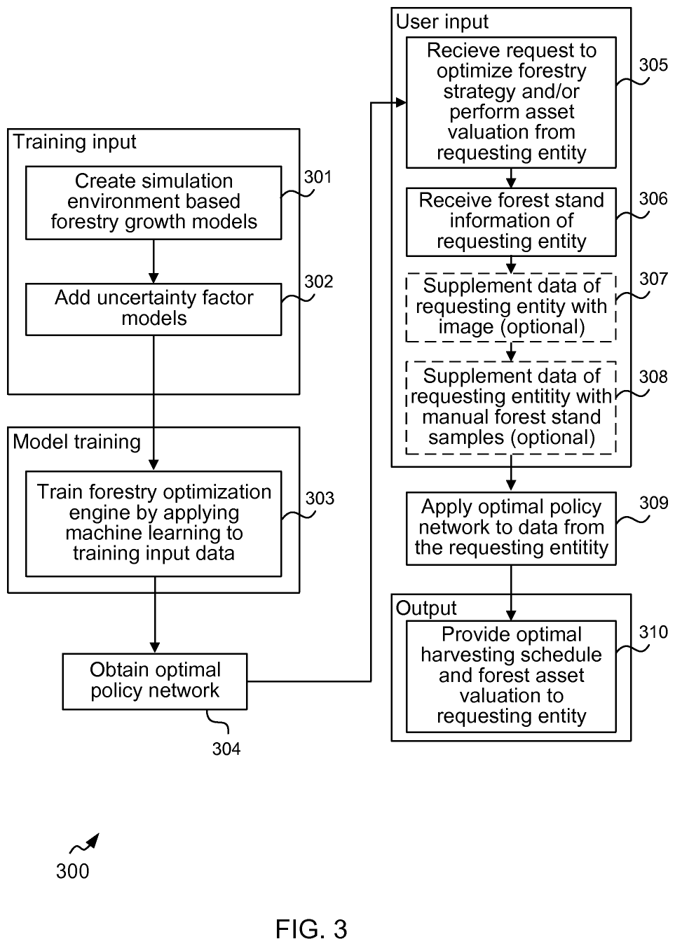

FIG. 3 illustrates an example flow chart of a method 300, in accordance with an example embodiment.

Operations 301-303 relate to training input described above in more detail.

At optional operation 301, one or more simulation environment-based forestry growth models may be generated by the apparatus 200.

At optional operation 302, one or more uncertainty factor models may be added by the apparatus 200.

Operation 303 relates to model training described above in more detail.

At optional operation 303, the forestry optimization engine 203C may be trained by the apparatus 200 by applying machine learning to the training input data of operations 301-302.

At optional operation 304, an optimal policy network may be obtained by the apparatus 200 as a result of the operations 301-303.

Operations 305-308 relate to user input described above in more detail.

At optional operation 305, a request to optimize a forestry strategy and/or to perform asset valuation may be received by the apparatus 200 from a requesting entity.

At operation 306, a set of input data related to a forest stand is accessed by the apparatus 200. For example, forest stand information may be received by the apparatus 200 from the requesting entity.

At optional operation 307, the data from the requesting entity may be supplemented with image data.

At optional operation 308, the data from the requesting entity may be supplemented with manual forest stand samples.

At operations 309-310, a forest management plan defining at least one forest management activity for the forest stand is determined by the apparatus 200 based on the accessed set of input data and at least one forest management preference. The determining of the forest management plan for the forest stand is performed by applying a parameterized policy to the accessed set of input data, the parameterized policy having been trained via a machine learning process using a forest development related simulation model. In other words, at operation 309, the optimal policy network obtained at operation 304 may be applied by the apparatus 200 to the data from the requesting entity of operations 305-308. At operation 310, an optimal harvesting schedule and/or forest asset valuation may be provided by the apparatus 200 to the requesting entity.

Then, decision making (concerning, e.g., felling of trees and/or extraction of timber from the forest for further processing) may be performed based on the optimal harvesting schedule and/or the accurate forest asset valuation resulting from operation 310.

Furthermore, the optimized harvesting schedule resulting from operation 310 may be implemented in practice. For example, the optimized harvesting plan may be given to chainsaw operators who cut trees accordingly. In another example, the plan may be forwarded to smart harvesting machines.

At least parts of the method 300 may be performed by the apparatus 200 of FIGS. 2A and 2B. At least operations 301-310 can, for example, be performed by the at least one processor 201 and the at least one memory 202. Further features of the method 300 directly result from the functionalities and parameters of the apparatus 200, and thus are not repeated here. At least parts of the method 300 can be performed by computer program(s).

The apparatus 200 may comprise means for performing at least one method described herein. In one example, the means may comprise the at least one processor 202, and the at least one memory 204 including program code configured to, when executed by the at least one processor, cause the apparatus 200 to perform the method.

The functionality described herein can be performed, at least in part, by one or more computer program product components such as software components. According to an embodiment, the apparatus 200 may comprise a processor configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and Graphics Processing Units (CPUs).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. An apparatus comprising:
at least one processor; and
at least one memory including computer program code;
the at least one memory and the computer program code configured to, with the at least one processor, cause the apparatus to at least perform:
accessing a set of input data related to a forest stand; and
determining a forest management plan defining at least one forest management activity for the forest stand based on the accessed set of input data and at least one forest management preference,
wherein the determining of the forest management plan for the forest stand is performed by applying a parameterized policy to the accessed set of input data, the parameterized policy having been trained via a machine learning process using a forest development related simulation model.

2. The apparatus according to claim 1, wherein the set of input data comprises at least one of size data, species data, quantity data, or age data of trees in the forest stand.

3. The apparatus according to claim 2, wherein the set of input data further comprises image data related to the trees in the forest stand.

4. The apparatus according to claim 1, wherein the at least one forest management preference comprises at least one of maintaining biodiversity of the forest stand, improving carbon storage of the forest stand, maximizing timber revenue of the forest stand, or maximizing harvesting profit of the forest stand.

5. The apparatus according to claim 1, wherein the at least one forest management activity comprises an instruction to apply at least a thinning or a clearcut to the forest stand, or an instruction to wait.

6. The apparatus according to claim 1, wherein the at least one forest management activity further comprises a harvesting schedule for the forest stand.

7. The apparatus according to claim 6, wherein the harvesting schedule comprises at least one of a harvest target, a harvest timing, or a harvest intensity.

8. The apparatus according to claim 1, wherein the at least one forest management activity further comprises at least one of a scenario-based carbon analysis for the forest stand or a scenario-based sustainability analysis for the forest stand.

9. The apparatus according to claim 1, wherein the forest development related simulation model comprises at least one of:
a deterministic forest development related simulation model comprising a forestry growth model with no uncertainty factor model; or
a stochastic forest development related simulation model comprising a forestry growth model and an uncertainty factor model.

10. The apparatus according to claim 9, wherein the uncertainty factor model is based on at least one of a random tree factor, a weather factor, a natural disaster factor, or an economic risk factor.

11. The apparatus according to claim 1, wherein the forest development related simulation model further comprises an empirically estimated model for forest dynamics.

12. The apparatus according to claim 11, wherein the forest dynamics comprise at least one of diameter increment, mortality or natural regeneration of trees.

13. The apparatus according to claim 1, wherein the forest stand comprises a single-species forest stand or a multiple-species forest stand.

14. The apparatus according to claim 1, wherein the forest stand comprises an even-aged forest stand or an uneven-aged forest stand.

15. The apparatus according to claim 1, wherein the machine learning process comprises a reinforcement learning, RL, process, an approximate dynamic programming process, or an evolutionary computation process.

16. A method comprising:
accessing, by an apparatus, a set of input data related to a forest stand; and
determining (309-310), by the apparatus, a forest management plan defining at least one forest management activity for the forest stand based on the accessed set of input data and at least one forest management preference,
wherein the determining of the forest management plan for the forest stand is performed by applying a parameterized policy to the accessed set of input data, the parameterized policy having been trained via a machine learning process using a forest development related simulation model.

17. A computer program comprising instructions for causing an apparatus to perform at least the following:
accessing a set of input data related to a forest stand; and
determining a forest management plan defining at least one forest management activity for the forest stand based on the accessed set of input data and at least one forest management preference,
wherein the determining of the forest management plan for the forest stand is performed by applying a parameterized policy to the accessed set of input data, the parameterized policy having been trained via a machine learning process using a forest development related simulation model.

18. (canceled)
